(19) United States
(12) Patent Application Publication
(10) Pub. No.: US 2006/0082221 A1
(43) Pub. Date: Apr. 20, 2006

(54) Vehicle sidelight control system

(76) Inventor: Alexander Mouzas, Saco, ME (US)

Correspondence Address: Charles F. Seyboldt, 19 Ridgeview Drive, Standish, ME, 04084, US

(21) Appl. No.: 10/528,129

(22) PCT Filed: Oct. 2, 2004
(86) PCT No.: PCT/US04/32957

§ 371 Date: Mar. 11, 2005

(30) Foreign Application Priority Data
Oct. 3, 2003 (US) 60508710

(51) Int. Cl. B60L 1/00; H02G 3/00; B60L 3/00

(52) U.S. Cl. 307/10.1

(57) ABSTRACT

A vehicle sidelight control system is provided that automatically illuminates right or left sidelights inautomatic response to turning of a steering wheel or motorcycle handlebar, or in response to a vehicle movement that will operate a gravity-effective switch, such as the leaning of a motorcycle in a turn. In one embodiment, the gravity-effective switch assembly further incorporates control logic and a wireless transmitter, making aftermarket installation a simple task. The control system is extensible to manual control and/or cooperation with signals that otherwise exist in the vehicle. The control system can be used to operate decorative lights, or any auxiliary function that is desired to be associated with turning of a vehicle, instead of or in addition to operating sidelights.

### BACKGROUND OF THE PRESENT INVENTION

### SUMMARY OF THE PRIOR ART

This invention relates to a sidelight control system, and more particularly to a sidelight control system that includes a gravity responsive automatic input device that can be applied to automobiles, trucks, trailers and motorcycles.

Control of vehicle lighting is known in several forms, including the use of sidelights to enhance visibility of roadways, curbs and other obstacles during a vehicle turning maneuver. Sidelights or other auxiliary lighting can also be useful during parking or reversing. In a broader sense, the present invention is also useful to activate decorative or vanity lighting, for example undercarriage lighting activated in response to and during a motorcycle wheel-stand stunt.

U.S. Pat. No. 5,479,323, to Shibata et al., discloses a sidelight illumination control system that uses an angular velocity sensor (1) (or, in the alternative, a lateral acceleration sensor (19)) and a distance/velocity sensor (2) as inputs to an analog circuit that “calculates” and provides an analog output to drive the turning of headlamps (18) to a desired illumination position based on one of several calculation algorithms.

U.S. Pat. No. 5,682,138, to Powell et al., discloses the illumination of a sidelight (13) under the control of a circuit (11) that provides a “sidelight on” signal when the taillight (15) and turn signal lamp (9) are on at the same time. Circuit (11) has a “sidelight off” delay.

U.S. Pat. No. 5,712,618, to McKenna, discloses a system for use on a vehicle that provides a “sidelight on” signal depending on computations related to one or more of: sensed lateral velocity, lateral acceleration, a proportional signal describing steering wheel angle, β, and/or vehicle forward velocity.

In several places, the McKenna patent recites, without providing structure, “means for determining a turnable wheel angle β.” The disclosure indicates that the signal from the means for determining the angle is analogue in nature, that is, that the turnable angle β is always being ascertained within the sidelight control scheme, and the control logic involves a trigonometric calculation using turnable angle β.

In contrast, the control scheme of the present invention involves knowing only that a discrete angle of steering wheel turning has occurred, with a logical “on/off” signal being provided by reaching the setpoint of one of the provided gravity responsive sensors. Further, the instigation of a “light on” command under the control system of the present invention does not involve a trigonometric calculation.

U.S. Pat. No. 6,177,867, to Simon et al., discloses the use of wireless transmission in the context of a motor vehicle. Lights on the vehicle are controlled by controllers (25 and 26), which in turn are responsive to wireless communications received from another control circuit (27). Control circuit (27) is described as able to receive inputs from driver-operated manual switches (30), and/or from other vehicle generated signals that appear on a data communications bus (36).

The invention of Simon uses the Digital Enhanced Cordless Telecommunications (DECT) protocol for the wireless communications of serial data from input-transmitting control circuit (27) to receiving-output control circuits (25 and/or 26), and uses the receiving-output control circuits to operate headlights (24), braking lamps (21), and turn signal lamps (22 and 23).

U.S. Pat. No. 6,332,699, to Lee, discloses a vehicle-mounted lamp body having two lamp assemblies (2 and 3), with one lamp assembly being aimed to the right and the other to the left of straight-ahead vehicle travel. Input to the control that determines activation of the lamps is described (but without particularity) as being provided by a sensor system having sensed parts that move with the steering wheel and a proximity sensing part that can detect the sensed parts. The control logic is likewise generally described as comprising a microcomputer circuit, but without particular definition to its logic other than a right turn of the steering wheel results in illuminating one the lamp assemblies (e.g., 2) and a left turn of the steering wheel illuminates the other lamp assembly (e.g., 3).

U.S. Pat. No. 6,677,856, to Perlman et al, discloses wireless means and apparatus for activating remote signal indicators that are in addition to vehicle-standard front and rear mounted turn-signal indicators. That is, a wirelessly activated remote signal indicator system. The signals that are accommodated are turning, braking, reverse and hazard. Remote signal indicators (100) are responsive to wireless signals (110) transmitted by and received from transmitter (210). Transmitter (210) is described as taking input signals from a turn signal indicator (232 or 234), turn signal monitoring lines (270 or 280), turn signal line taps (220 or 230), or turn signal generator (202) that is actuated when a person operates the turn signal lever on the steering column.

U.S. Pat. No. 6,698,911, to Naganawa et al., discloses a multi-filament and multi-axis lamp assembly (10 or 30) for providing a progressive lighting effect oblique to a vehicle's straight travel direction depending on the commands of a control unit (20 or 40). Control unit (20 or 40) is described as obtaining inputs relating to vehicle speed, vehicle position and steering wheel angle. An output function of sequencing the lights is described relative to vehicle position on a roadway, but Naganawa's specification does not particularly describe the devices that provide input signals to control units (20 or 40) nor how a control unit processes the input signals to arrive at output signals, nor how the output signals are transmitted to the multi-filament multi-axis lamp assembly.

U.S. Pat. No. 5,428,512, to Mouzas, discloses a vehicle sidelight system (10) having a controller (16 or 18) responsive to a signal from a steering wheel sensor (14) or from a signal that pertains to the condition of the manually activated turn signal lever. The steering wheel sensor of Mouzas comprises a sensed part (e.g. magnet or metal part 30) that moves with the steering wheel and stationary proximity sensing parts (32) that can detect the sensed parts. With regard to the steering wheel sensor, the logic of the controller depends on noting the sequence of operation of the proximity sensing parts. The controller of Mouzas can alternatively be responsive to only the turn signal lever position (as detected anywhere in the vehicle-standard turn signal circuits); to only the detected motion of the steering wheel; or to both.

The Hella KGaA Hueck & Co. Dynaview® system and IntelliBeam® sensor are designed to automatically provide vehicle sidelight illumination, in response to forces generated when a moving vehicle changes direction.
“Hella Dynaview driving lights make the most of Hella Intellibeam” technology. These ingenuious aftermarket lights are equipped with a sensor that monitors the transverse acceleration of the vehicle (vehicle yaw) and automatically switches the appropriate cornering headlamp on at the beginning of each bend. The result is remarkable, rendering it impossible to driving into a completely blind corner at night.
“As soon as Hella's yaw rate sensor detects the corner, it switches the appropriate cornering lamp on. At the same time a dimmer gently and automatically decreases the brightness of the cornering lamp beam to prevent “holes” appearing in the beam. One Dynaview headlamp actually consists of two headlamps in a high tech housing with dual reflectors. The upper reflector chamber is responsible for the conventional high beam, while the lower reflector chamber has been optimised to produce the inside illumination of the curve using asymmetrical free-form technology. (There are no moving parts to in the Hella Dynaview whatsoever).”
http://www.hella.com.au/latestnews/PR_archive/PR_info_htmlpages/dynaview20_{—}11_{—}02.html

The desirability of side illumination during turning is well established. An object of the present invention is a sidelight illumination control system that is inexpensive to produce and install in either aftermarket or OEM contexts. The present invention admits a variety of input means, at least one of which is responsive to a gravity-derived signal; and admits a variety of signal transmission means, including hardwired and wireless.

### SUMMARY OF THE PRESENT INVENTION

The present invention contemplates a compact and unitary input and controller that can be applied to motor vehicles for the purpose of lighting side-illumination lamps to improve illumination during turning maneuvers. The input, control and output functions can be configured in many forms.

While the discussion below is couched in terms of illuminating side lights for the purpose of improved visibility while cornering, the present invention could be used to illuminate vanity or decorative lights (for example, under a motorcycle during a wheel-stand stunt), or to actuate a headlight steering mechanism, to automatically activate a turn-signal circuit, to move a mirror, to actuate a side window cleaning apparatus, or any other function that one desires to associate with vehicle turning activity.

The input aspect of the controller has automatic turn detection in the form of one or more gravity-responsive (also known as “tilt”) switches. In an automobile or truck application, the gravity-responsive switches can be attached to the steering wheel or the turn signal lever. When the steering wheel is turned far enough to the right, one of the switches will change state; and when the steering wheel is turned far enough to the left, a different switch changes state. Likewise, the gravity-responsive switches can be mounted to the turn-signal lever, where flipping the lever “up” will cause one of the switches to change state, and flipping the lever “down” will cause the other switch to change state.

In a motorcycle application, the gravity-responsive switches can be attached to the frame of the motorcycle (e.g., under the seat), or to the front forks. When the motorcycle leans far enough (for turning), one of the switches will change state.

In another embodiment, rather than detect the right or left leaning of the motorcycle, a gravity-responsive switch can be arranged to detect a wheel-stand stunt maneuver, and/or a rear-wheel raising maneuver caused by hard front wheel braking.

In addition to the input provided by one or more gravity-responsive switches, the controller could obtain inputs from additional devices. For example, manual switches could be provided as part of the system, where actuating a manual switch would cause the controller to produce or vary its output signal(s). Manual switches could be located on a vehicle dashboard, or mounted to the steering wheel rim for convenient access.

Examples of inputs that might produce or vary a controller's output include: a light detecting photocell, to stifle the operation of side lighting during daylight; a system on-off switch to manually stifle sidelights; a “right-on” and “left on” switch to operate the lights when the vehicle is not being turned; and a signal from a voice-activated switch.

Another embodiment of the input aspect of the controller system is to obtain input signals from events that exist in the vehicle, independent of the gravity-responsive switch (or switches) and any manual switches. For example, the presence of voltage or current in the vehicle's turn signal, parking light, headlight, brake light, reverse light, hazards light, horn, anti-theft system, proximity sensing system (i.e., a system that detects the presence of an object near the vehicle), remote keyless entry system, and/or dome light circuit could be input to the controller.

Yet another group of input devices is accessories that are not part of the vehicle, and are not manually activated. For example, a signal from a portable GPS, that indicates a rate of change in vehicle direction.

The controller receives input signals, and processes them to arrive at an output signal. For turning applications, the output signal will be at least either “activate right” or “activate left.” For a wheel-stand stunt detection application, the output signal will be at least “activate.”

A controller of some sort is desirable (rather than operate the output function, e.g., sidelight, directly on change of state of the gravity-responsive switch(es)) because the on/off state of the switch(es) can change more than once as the steering wheel is rotated to make a turn. Also, a controller is used to prioritize conflicting input signals, such as the gravity responsive is switches indicating a right hand turn, while the turn signal lever is indicating a left hand turn. A controller can also be used to provide a function that is not obtainable via logical combinations of on-off inputs alone; for example an off-delay or a dimming function.

The present invention contemplates the possibility of multi-stage operation, where more turning (or sharper leaning) is detected by a second set of gravity-responsive switches, that change state at a different degree of rotation than the first set. In this embodiment, the controller would output a different or an additional “activate 2^{nd} right” or “activate 2^{nd} left” signal, which might be used to activate additional sidelights, or some other additional auxiliary function. The number of stages might be 2, 3, 4 or more.

In the preferred embodiment, the gravity-responsive switch(es) and the controller are unitary. In one of the preferred embodiments, the output signal(s) from the controller are transmitted by a wireless transmitter, which is also unitary with the package that contains the gravity-responsive switches and the controller. This “switch-controller-transmitter” package can be made small enough that it can be unobtrusively mounted on a steering wheel, on the steering column (shaft), or turn signal lever (stalk).

The “switch-controller-transmitter” package is contemplated to be powered by a battery. In one embodiment, the “switch-controller-transmitter” package is also provided with a photocell and circuit so that exposure to sunlight will maintain the charge on the battery. By mounting the “switch-controller-transmitter” on the top of the steering wheel hub, the photocell can be exposed to daylight.

In another preferred embodiment, the output signal from the controller is hardwired to the means of activating the auxiliary function, which is typically a relay.

The totality of a sidelight (or accessory) control system involves devices that create input signals (e.g., switches), devices that process the input signals into output signals (controllers), devices that switch power to the auxiliary function (e.g., relays), and the device that provides the auxiliary function (e.g., a lamp filament).

The present invention contemplates that the function of a controller can be obtained by a cooperating series of controllers. For example, a first controller may be responsive to the gravity-responsive switch inputs, and transmit its output to a second controller. A second controller could be responsive to the output of the first controller, and also to additional inputs such as manual switch inputs and/or in-vehicle signals, and transmit its output to a third controller. A third controller could be responsive only to the second controller, and could activate the sidelight (or accessory). Any combination of hard wired and wireless transmission means could be provided between the inputs and controllers, and any number of inputs and controllers could be provided to suit the vehicle and user's preferences.

The point of providing a distribution of controllers is to provide convenient means to accommodate (or not) the features that an individual driver desires to have. For example, a unitary package of gravity-responsive switches with a power supply (battery), controller and wireless transmitter (mounted to the hub of the steering wheel) could directly activate a unitary package comprising a receiver, power supply and auxiliary function, e.g. an auxiliary turn signal as described in U.S. Pat. No. 6,677,856 to Perlman.

Steering wheel mounted switches could be hard wired to the unitary package described above, but dashboard mounted switches would not be conveniently hardwired without an intermediate input and/or controller location, i.e. a place other than on the steering wheel or on the outside of the vehicle.

Therefore, in another possible arrangement, the state of the gravity-responsive switches could be transmitted directly by a wireless transmitter to a receiver and controller (located elsewhere), where the controller also accepts inputs from manual switches, and where the controller could be packaged with an output relay.

Yet another embodiment has the gravity-responsive switches mounted to the turn signal handle or stalk. In this embodiment, hard wired transmission might be used to reach a dashboard mounted controller, where the dashboard mounted device has manually operated input switches, facilities for obtaining signals already existing in the vehicle, a controller for accepting these inputs, where the controller output is either hard-wired to power the accessory (or accessory relay), or has a wireless transmitter to send command signals to a receiver that in turn activates the accessory in response to the received command.

It can be seen that there are a great number of possible input-controller arrangements.

Likewise, the range of location and type of auxiliary lighting or auxiliary function is broad. Side lighting can be provided from many locations, generally selected to suit the area that is desired to be illuminated. Examples of side light location are: the front of a vehicle, side/running board locations, near the midpoint of a vehicles length, near the rear of a vehicle, on or near mud flaps, on top of the vehicle (and pointing in any desired direction), the sides of a towed trailer, on a trailer tongue, disposed on a post or stalk under the frame of a semi-trailer, integrated with parking, turn-signal or marker light assemblies, on the front of a motorcycle fairing, on motorcycle turn signal light stalks, or under a vehicle.

The present invention contemplates a completely unitary system as well, that requires only a source of power for operation. A completely unitary system would contain a gravity-responsive switch, a controller, a relay (if the controller can not drive the load directly), and the output function, e.g., lighting of a lamp. A completely unitary device could be rendered functional simply by fastening it to the vehicle and connecting one wire to the vehicle's source of electrical power. As discussed above, c variation on this approach is to provide additional inputs to the controller, such as detection of current or use of voltage in an existing vehicle circuit, typically a turn signal circuit. Because the input of the present invention relies on a gravity-responsive (or tilt) switch, this wholly unitary embodiment is seen as most likely useful on a motorcycle.

The present invention relates to a vehicle sidelight control system that may be adapted and adjusted to specific application details. In summary, it can be made responsive at more or less angular displacement of the steering wheel (or steering column/shaft, or turn signal lever/stalk), responsive to the physics of turning a motorcycle (i.e., angle of lean), responsive to motorcycle wheel-stand stunts, etc. It may be adapted to accept a range of additional input means, such as manual switches, and/or detection of otherwise existing in-vehicle signals such as turn, brake, reverse, hazard, anti-theft systems, proximity detection systems, keyless entry systems and/or open door, and/or detection of signals from accessories that are brought to the vehicle such as a portable GPS unit. The vehicle sidelight control system subsystems may be produced in configurations where the communication of switch state or controller output state is accomplished using hard-wired or wireless technology.

Specific features of the invention will be apparent from the above and from the following description of the illustrative embodiments when considered with the attached drawings and the appended claims.

### BRIEF DESCRIPTION OF THE DRAWINGS

FIG. 1 is a diagram of a vehicle sidelight control system showing a wireless transmitting sensor and controller attached to a steering wheel.

FIG. 2A is a rear view of a motorcycle showing a sensor and controller attached to the steering fork assembly.

FIG. 2B is a side elevation view of a motorcycle performing a wheel-stand stunt.

FIG. 3 is a block diagram of a wireless embodiment of a vehicle sidelight control system.

FIG. 4 is a block diagram of a cascade or series of controllers for operation of a vehicle accessory.

FIG. 5 is a diagram of a wireless sensing transmitter.

FIG. 6 is a diagram of an array of four gravity-sensitive switches.

FIG. 7 is a diagram of unitary sensing, control and output unit.

### DESCRIPTION OF THE PREFERRED EMBODIMENTS OF THE PRESENT INVENTION

In one embodiment, the vehicle sidelight control system of the present invention comprises a switch array of two or more gravity-sensitive angular displacement switches arrayed to detect discrete a certain degree of clockwise and counterclockwise rotation, where the array of switches is mounted either to the moving part of an automobile or truck steering wheel, usually near the steering column, or to the turn signal lever, or stalk.

Both the steering wheel and the turn-signal stalk rotate about an axis on manual input from the driver, and this is rotation will result in a change of state of the switch array.

FIG. 1 is a diagram of a vehicle sidelight control system showing a wireless transmitting sensor and controller attached to a steering wheel.

In FIG. 1, wireless transmitting sensor and controller (10) is mounted to a part of steering wheel (90). As steering wheel (90) is rotated clockwise, point “A” on the steering wheel will approach the angle designated as “B”, and as steering wheel (90) is rotated counter-clockwise, point “A” on the steering wheel will approach the angle designated as “C”. Wireless transmitting sensor and controller (10) goes through the same angular displacement as steering wheel (90) as the steering wheel is turned.

When steering wheel (90) is rotated to angle “B” for the first time, a gravity-sensitive switch in wireless transmitting sensor (10) changes state. A controller in wireless transmitting sensor (10) detects this first change in state, and transmits a coded signal (500). Antenna (260) on wireless receiving controller (20) receives coded signal (500), and causes right hand sidelight (320) to illuminate. In similar fashion, when steering wheel (90) is rotated counter-clockwise to angle “C” (from centered position), a second gravity sensitive switch in wireless transmitting sensor (10) changes state. The controller in wireless transmitting sensor (10) detect this change in state and transmits coded signal (500). Antenna (260) on wireless receiving controller (20) receives coded signal (500), and causes left hand sidelight (310) to illuminate.

If the driver continues turning the steering wheel, for example counter-clockwise, past angle “C”, one or both of the gravity-sensitive switches in wireless transmitting sensor (10) will reverse their change in state. The controller in wireless transmitting sensor (10) keeps track of which gravity-sensitive switch first changed state, and counts further changes of state in both switches in order to produce an appropriate signal for the direction the vehicle is being turned. U.S. Pat. No. 5,428,512 to Mouzas describes a control logic that accomplishes this function.

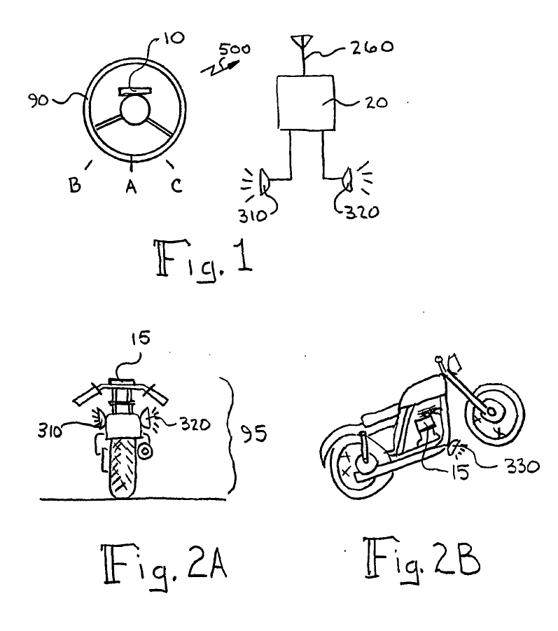

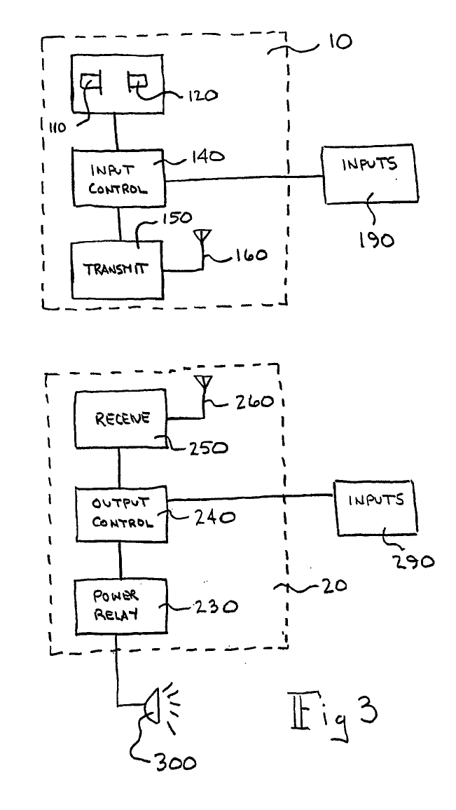

FIG. 2A is a rear view of a motorcycle showing a sensor and controller attached to the steering fork assembly.

Motorcycle (95) is illustrated in the upright position, with a sensor and controller unit (15) mounted on the steering fork assembly. When motorcycle (95) is leaned a certain amount to the right, a gravity-sensitive switch in sensor and controller unit (15) changes state. The controller processes this input and sets a chain of command events in motion that result in the illumination of right side light (320). Similarly, for a left hand lean, the sensor and controller unit will initiate command events that result in the illumination of left side light (310).

Sensor and controller unit (15) need not be mounted on the steering fork assembly. It could be mounted under the seat, on a fender, or in any convenient location on the motorcycle. The only requirement is to locate the sensor and control unit so that it is sensitive to the leaning motion that results from turning the motorcycle.

FIG. 2B is a side elevation view of a motorcycle performing a wheel-stand stunt.

In yet another motorcycle embodiment, sensor and controller unit (15) can be mounted so that it detects wheel-stand stunt maneuvers and/or rear wheel rises caused by hard braking on the front wheel and tire. When motorcycle (95) is pitched a certain, a gravity-sensitive switch in sensor and controller unit (15) changes state. The controller processes this input and sets a chain of command events in motion that result in the illumination of undercarriage light (330).

FIG. 3 is a block diagram of a wireless embodiment of a vehicle sidelight control system.

Wireless transmitting sensor (10) comprises gravity-sensitive switches (110 and 120), input controller (140), transmitter (150) and transmitting antenna (160). Input controller (140) provides an output signal or command that depends on the change(s) in state of gravity-sensitive switches (110 and 120), and provides the command to transmitter (150) which transmits a command signal via antenna (160). The command signal could be coded, to permit more than one type of command to be communicated by wireless transmitting sensor (10).

Further, input controller (140) of wireless transmitting sensor (10) could have more inputs than just gravity sensitive switches (110 and 120). For example, an optional manual switch or switches (190) mounted on the steering wheel could be hard wired to input controller (140) to permit manual operation of the vehicle accessory without activation of the gravity-sensitive switches.

Wireless receiving controller (20) comprises a receiving antenna (260), receiver (250), output controller (240), and output relay (230). The command signal produced by wireless transmitting sensor (10) is detected by receiver (250), and provided to output controller (240). Output controller (240) determines whether to produce an output signal depending on coded logic from receiver (250), and from the condition of inputs (290). Power controlling relay (230) responds to the output signal from output controller (240), and causes power to be delivered to vehicle accessory (300), illustrated as a light.

A wireless receiving controller (20) could have more than one power controlling relay, and output controller (240) can be configured to provide more than one output signal. In this fashion, a version of wireless receiving controller (20) can operate more than one vehicle accessory (300).

Wireless receiving controller (20) is preferably located on or near the dashboard or fire wall, that is, it is stationary with respect to the vehicle. Being so situated, output controller (240) can conveniently be configured to obtain signals from hard wired inputs (290) that are also stationary with respect to the vehicle (unlike input controller (140) which might be rotating with the steering wheel). These hard wired inputs might derive from manual or voice activated switches, current or voltage sensing on turn-signal, braking, reverse, hazard, horn, anti-theft system, proximity sensing system, and/or keyless entry system; as well as from driver provided portable accessories such as global positioning system devices (GPS).

The system might, on its own, be provided with a manual on/off switch, and/or a photocell to stifle the operation of the vehicle accessories during daylight house. These system inputs could be via input controller inputs (190), or via output controller inputs (290), depending on convenience of construction and operation.

Wireless receiving controller (20) could also be configured to accept wireless signals from sources other than wireless transmitting sensor (10). In other words, wireless inputs can be provided to output controller (240), besides or in addition to hard wired inputs (290).

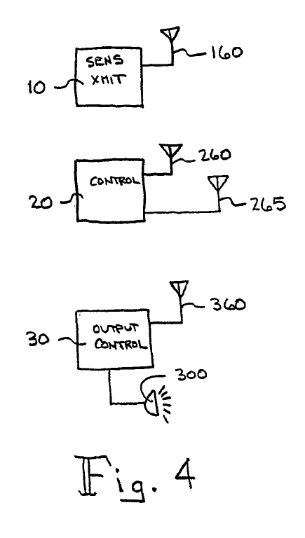

FIG. 4 is a block diagram of a cascade or series of controllers for operation of a vehicle accessory.

The power controlling relay (230) shown in wireless receiving controller (20) could, instead of or in addition to operating power controlling relay(s) (230), provide a wireless signal via antenna (265) that is distinguishable from the signal transmitted by wireless transmitting sensor (10). This configuration permits a wide range of location of manual and automatic (or tag-along, as in the case of vehicle-generated signals) inputs to the control scheme that ultimately controls providing power to the vehicle accessory (300).

The wireless receiving output controller (30) as illustrated in FIG. 4 could located on the exterior of the vehicle, or on a trailer or other remote location such that hard wiring as illustrated in FIG. 3 is not as convenient or practical as wireless communication.

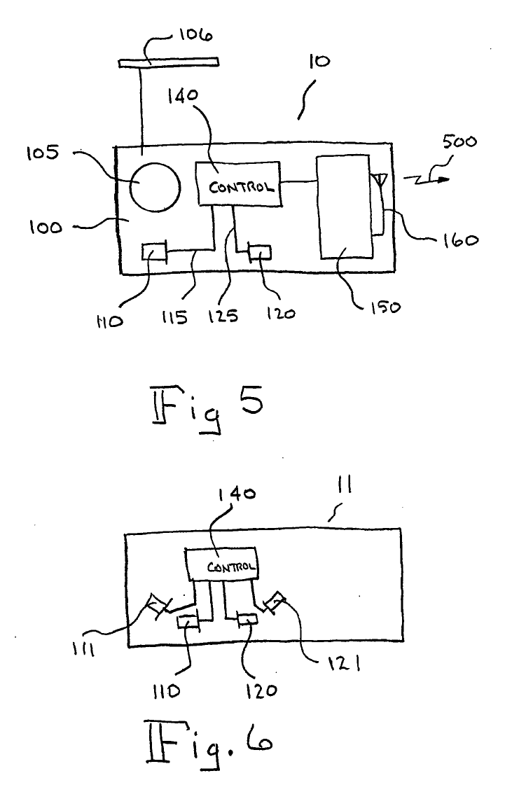

FIG. 5 is a diagram of a wireless sensing transmitter.

Wireless transmitting sensor (10) is contemplated to be powered by a battery (105). A first gravity-sensitive switch (110) communicates with input controller (140) via communication line (115). A second gravity sensitive switch (120) communicates with input controller (140) via communication line (125). The output signal(s) of output controller (140) are communicated to transmitter (150). Gravity-sensitive switches (110 and 120), input controller (140), transmitter (150) and battery (105) may all be mounted to a singe printed circuit board (100). Transmitter (150) provides a signal to antenna (160) that is propagates it as wireless signal (500).

In one embodiment, a photocell (106) and charging circuit are provided for wireless transmitting sensor (10) to facilitate maintaining charge on the battery, via exposure of the photocell to sunlight.

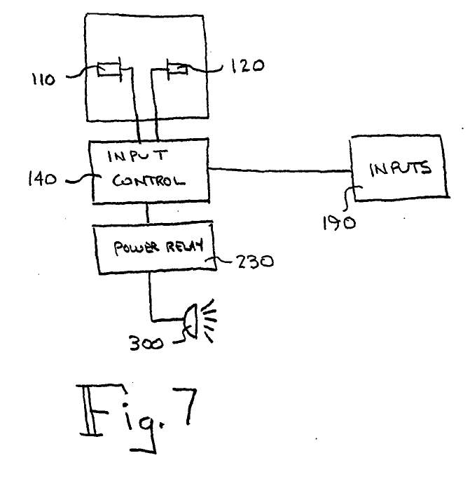

FIG. 6 is a diagram of an array of four gravity-sensitive switches.

It is known that a range of outputs may be desired depending on the degree of steering wheel turn, or of motorcycle tilt. For example, according to the lighting arrangement described in U.S. Pat. No. 6,698,911 to Naganawa et al. The array of switches shown in FIG. 6, in combination with suitable control logic facilitates that objective.

When switch array (11) is rotated, the first gravity-responsive switch to change state will be (110) or (120), depending on the direction of rotation. On continued rotation in the same direction, either switch (111) or (121) will next change state. Controller (140) can process these signals by counting, and determine a suitable output.

In all of the above-referenced control schemes, is controllers (140 or 240, etc.) are contemplated to be capable of timing and other functions, so that turning off of the vehicle accessory can be delayed for a period after the input devices have attained a steady state, which is usually associated with nominal straight ahead driving.

FIG. 7 is a diagram of unitary sensing, control and output unit.

The present invention contemplates that where wireless transmission is indicated between a wireless transmitting sensor and a wireless receiving controller, a simplified embodiment is also possible by omitting the wireless transmission and reception steps. The simplified embodiment is practical for motorcycle and turn signal stalk applications, where neither the wrapping of the communications wires around the steering column, nor the communication with a remote vehicle accessory is a consideration.

Gravity-sensing switches (110 and 120) are mounted so as to sense either a driver move (e.g., manipulation of turn signal stalk), or a vehicle move (e.g., tilting of a motorcycle). Input control (140) receives information about the state of the gravity-sensing switches (110 and 120), and can optionally receive inputs (190) other than from the gravity-sensing switches. Power controlling relay (230) responds to the output signal from input controller (140), and causes power to be delivered to vehicle accessory (300), illustrated as a light.

While all of these functions can be hard-wired, it is contemplated that their physical separation can range from having everything, from gravity sensing switches (110 and 120) to the vehicle accessory (300), contained in a unitary housing, to having discrete packages and locations for the gravity-sensing switches (110 and 120), the input control (140), the power controlling relay (230) and the vehicle accessory (300); with any combination of packaging being within the scope of the present invention.

The present invention, described above, relates to a vehicle sidelight control system. Features of the present invention are recited in the appended claims. The drawings contained herein necessarily depict structural features and embodiments of the vehicle sidelight control system, useful in the practice of the present invention.

However, it will be appreciated by those skilled in the arts pertaining thereto, that the present invention can be practiced in various alternate forms, proportions, and configurations. Further, the previous detailed descriptions of the preferred embodiments of the present invention are presented for purposes of clarity of understanding only, and no unnecessary limitations should be implied therefrom. Finally, all appropriate mechanical and functional equivalents to the above, which may be obvious to those skilled in the arts pertaining thereto, are considered to be encompassed within the claims of the present invention.

What I claim is:

1. A vehicle auxiliary function control system, for a vehicle that has a steering control element, a lever-operated turn-signalling element, and an auxiliary function, comprising:
a switch assembly having a pair of gravity-responsive switches, where the first gravity-responsive switch changes state on clockwise rotation of the switch assembly and the second gravity-responsive switch changes state on counter-clockwise rotation of the switch assembly;
a controller having inputs for the state of the first and second gravity-responsive switches and providing an output signal depending on the order and number of changes of state of the first and second gravity-responsive switches;
means to communicate the controller output signal; and
means for powering the vehicle auxiliary function in response to the controller output signal.

2. A vehicle auxiliary function control system, for a vehicle that has a steering control element and an auxiliary function, comprising:
a gravity-responsive switch
a controller having an input for the state of the gravity-responsive switch and providing an output signal depending on the timing and number of changes of state of the gravity-responsive switch;
means to communicate the controller output signal; and
means for powering the vehicle auxiliary function in response to the controller output signal.

3. A vehicle auxiliary function control system as described in claim 1, where the switch assembly is mounted on the vehicle steering control element.

4. A vehicle auxiliary function control system as described in claim 1, where the switch assembly is mounted on the vehicle lever-operated turn-signalling element.

5. A vehicle auxiliary function control system as described in claim 1, where the vehicle further has electrical circuits used to facilitate indication of one or more of: turning, braking, reversing, hazard, theft, keyless entry and horn:
where the controller further has inputs to detect the activation of one or more of the vehicle electrical circuits, selected from one or more of turning, braking, reversing, hazard, theft, keyless entry and horn.

6. A vehicle auxiliary function control system as described in claim 1, further comprising a manually operated switch, and where the controller further has an input for the manually operated switch and the controller outputs an “accessory on” signal in response to the position of the manually operated switch.

7. A vehicle auxiliary function control system as described in claim 5, further comprising a manually operated switch, and where the controller further has an input for the manually operated switch and the controller outputs an “accessory on” signal in response to the position of the manually operated switch.

8. A vehicle auxiliary function control system as described in claim 1, further comprising a wireless transmitter and a wireless receiver;
where the switch assembly, controller and wireless transmitter are unitary and the controller output signal is sent via the wireless transmitter; and
where means for powering the vehicle auxiliary function includes the wireless receiver.

9. A vehicle auxiliary function control system as described in claim 1, where the switch assembly further has a second pair of gravity-responsive switches;
where the second pair of gravity-responsive switches change state at either more or less rotation of the switch assembly than is required to change the state of the first pair of switches;
where the controller further has inputs for the state of the third and fourth gravity-responsive switches; and
the controller further provides an output signal depending on the order and number of changes of state of the third and fourth gravity-responsive switches.

10. A vehicle auxiliary function control system as described in claim 1, wherein the vehicle auxiliary function is a cornering light.

11. A vehicle auxiliary function control system as described in claim 10, wherein the cornering light is integral with a vehicle side marker light.

12. A vehicle auxiliary function control system as described in claim 2, where the switch assembly and controller comprise an input-control-output unit, and where the controller output signal is delivered to the means for powering the vehicle auxiliary function via a wire.

13. A vehicle auxiliary function control system as described in claim 12, wherein the switch assembly is responsive to the performance of a motorcycle wheel-stand stunt.
